(19) United States
(12) Patent Application Publication
(10) Pub. No.: US 2012/0317620 A1
(43) Pub. Date: Dec. 13, 2012

(54) Website visitor identification algorithm

(76) Inventors: Aleksey Fefelov, Ulyanovsk (RU); Gennady Bobrov, Ulyanovsk (RU); Anton Martynov, Ulyanovsk (RU); Denis Martynov, Ulyanovsk (RU); Mikhail Galochkin, Ulyanovsk (RU); Dmitry Kanev, Ulyanovsk (RU)

(21) Appl. No.: 13/401,792

(22) Filed: Feb. 21, 2012

Related U.S. Application Data
(60) Provisional application No. 61/496,054, filed on Jun. 13, 2011.

(51) Int. Cl. G06F 21/00; G06F 15/16

(52) U.S. Cl. 726/4

(57) ABSTRACT

An improved method for identifying and counting the unique visitors to a website, comprising the redundant storage of information about the visitor in a first-party cookie, a third-party cookie, and a Flash cookie, enabling the persistence of visitor identification even if one of the abovedescribed cookies or some information therein is deleted by the visitor or otherwise unavailable.

### CROSS-REFERENCE TO RELATED APPLICATIONS

This application claims the benefit of Provisional Patent Application No. 61/496,054, filed Jun. 13, 2011, the contents of which is hereby incorporated by reference.

### BACKGROUND

1. Field of Invention

This invention relates to a method of passively identifying unique website visitors.

2. Prior Art

The number of visitors to a given website is an important metric. This number can be used to determine the cost of advertising on the site, to gauge the value of a site, or to determine the return on investment for that site. To make those numbers more accurate, it is important to determine how many visits to a website are by unique visitors, rather than repeat visits by the same visitor. Also, identifying a website visitor can help the website owner target the content and the advertisements to that particular visitor.

While a browser can set a “cookie” to identify a repeat visitor, cookies have many problems. A cookie is specific to a given browser; if a visitor uses a different browser on the same computer, the cookie will not help identify the visitor. Also, cookies can be blocked or deleted by the user, rendering persistent visitor identification impossible.

### SUMMARY OF THE INVENTION

The proposed method allows visitor identification using a highly redundant way of storing information about the visitor. The uniqueness of the visitor is determined by means of two codes—a local code (“l_code”) and a global code (“g_code”). On the client side, the codes are stored in three different objects: a first-party cookie, a third-party cookie, and a Flash cookie. On the server side, the codes are stored in a relational database. This redundancy in information storage allows the visitor code to be restored in the case of its absence from one of the abovementioned objects, and the visitor identification to persist even when cookies are deleted or when the visitor is using a different browser or visiting a different site. Using third-party cookies allows the site owner to perform cross-site identification, and using Flash cookies makes it possible to perform cross-browser identification.

The identification algorithm takes into account the fact that the third-party cookie or the Flash cookie may be unavailable for the browser if the browser does not support Flash or if it is set to a high security level. In that case, the visitor codes are stored within a first-party cookie that can still provide a basic level of service without the cross-domain or cross-browser identification option. If the security level is lowered and the third-party cookie becomes available, or Flash support is installed the Flash cookie becomes available, the identification algorithm automatically aggregates the visitor codes.

The foregoing and other objects, features, and advantages of the invention will become more readily apparent from the following detailed description of a preferred embodiment of the invention that proceeds with reference to the accompanying drawings.

### DESCRIPTION OF THE DRAWINGS

FIG. 1 shows a basic diagram of the main objects used in the website visitor identification algorithm of the present invention.

FIG. 2 shows a diagram of the data storage locations on the visitor's computer, stating the access level to these objects by external components.

FIG. 3 shows a diagram of basic and auxiliary codes used in the identification algorithm.

FIG. 4 shows the visitor local code structure.

FIG. 5 shows the visitor global code structure.

FIG. 6 shows the visitor session code structure.

FIG. 7 shows a block diagram of the identification process on the visitor's computer.

FIG. 8 shows a block diagram of the first authorization process on the server.

FIG. 9 shows a block diagram of the second authorization process on the server.

### DETAILED DESCRIPTION OF THE INVENTION

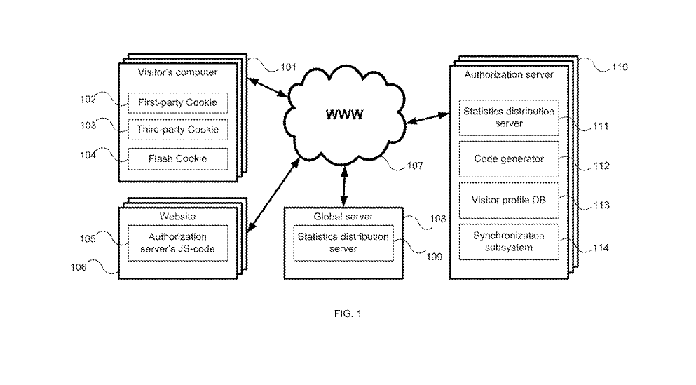

FIG. 1 shows a general diagram displaying the devices involved in the identification algorithm. All the components interact via the Internet 107 using the HTTP protocol. To run the algorithm, Javascript code 105 for the authorization server should be embedded in website 106. Once the Javascript code is embedded in the site, any visit to the website 106 will be tracked by the authorization server. The server comprises the following functional modules: the statistics distribution server 111, which is used for generation and distribution of Javascript scripts to the browser where the identification request originates; the code generator 112, which is used to create a unique visitor code for each visitor; visitor profile database 113, which is a relational database that stores website visitor data; and synchronization module 114, which synchronizes with the global server 108. The global server 108 is used to enable access to the third-party cookie 103 and the Flash cookie 104. The global server 108 also comprises the statistics distribution server 109, used for creating a Flash object for client-side access to the Flash cookie 104.

All the data required by the identification algorithm is stored on the visitor computer 101 in the following objects: first-party cookie 102 is one of the site's standard cookies, which are available via Javascript even when the browser is set to medium security level; third-party cookie 103 is a third-party cookie of the global server 108, used to make cross-domain identification possible; and Flash cookie 104 is a LSO (local shared objects) Flash cookie, used to make cross-browser identification possible.

This algorithm takes into account the fact that third-party cookie 103 or Flash cookie 104 may be unavailable for the browser if the browser does not support Flash or if the visitor's computer is set to a high security level. In that case, the visitor's code is stored within the first-party cookie 102, which provides a base service level without the cross-domain or cross-browser identification options. If the security level is lowered and third-party cookie 103 becomes available, or Flash support is installed and Flash cookie 104 becomes available, the identification algorithm aggregates the visitors' codes automatically. At that point, the code stored in the third-party cookie 103 replaces the code stored in the first-party cookie 102, and the code stored in the Flash cookie 104 replaces the code stored in the third-party cookie 103.

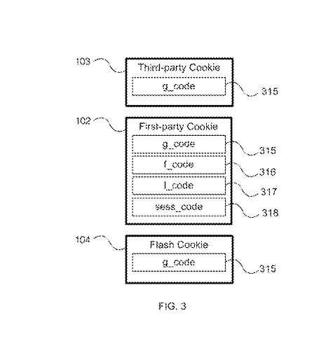

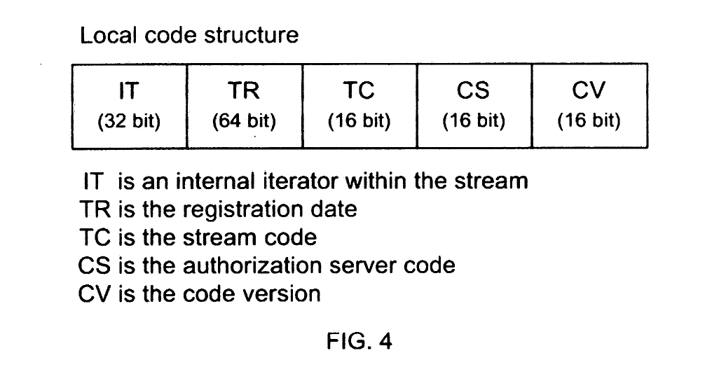

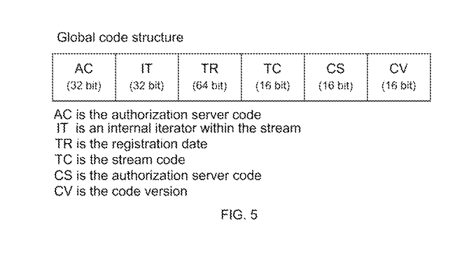

Visitor identification is performed by means of a local code (l_code) 317 and a global code (g_code) 315, which are embedded in the cookies as shown in FIG. 3. The structure of the local code 317 is shown in FIG. 4. The local code comprises the following fields: IT—an internal iterator within the stream, performing the visitor authorization process; TR—time of registration of the visitor on the authorization server; TC—stream code on the authorization server; CM—authorization module code; CV—version number. The structure of the global code 315 is shown in FIG. 5. The global code comprises the same fields as the local code, as well as the authorization server code (AC), which generates the visitor code. Full visitor identification is performed using both the local code (l_code) 317 and the global code (g_code) 315. However, it is possible for situations to arise when a visitor has only one of the two codes, or where the global code was generated by a different authorization server 110 (several authorization servers 110 may be used to distribute the load).

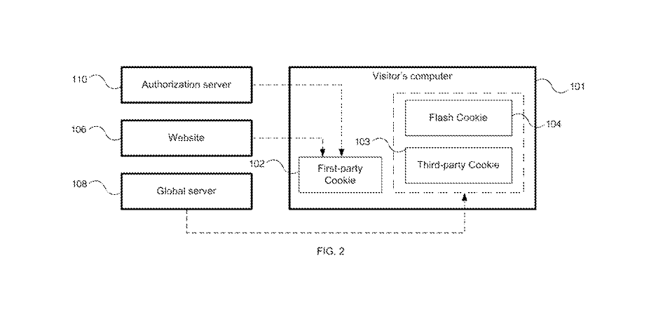

FIG. 2 shows a diagram of the access level of the various components involved in the authorization process. As is shown in the Figure, access to the Flash cookie 104 and the third-party cookie 103 is accomplished by means of a request to the global server 108, while first-party cookie 102 is accessed by the authorization server 110 via Javascript.

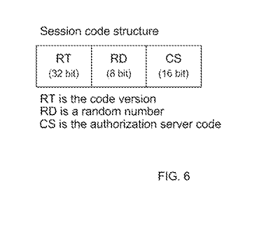

Another code involved in the authorization process is the session code 318 (sess_code), which is stored within the first-party cookie 102 as shown in FIG. 3 and is used within the current visitor's session to simplify the authorization process. The session code structure is shown in FIG. 6. The session code 318 contains three fields: CS is the code of the authorization server that generated the session code, RD is a random number, and RT is the version number of the code.

FIG. 3 shows the way the aforesaid codes are distributed and stored in the first-party cookie 102, third-party cookie 103, and Flash cookie 104 on the visitor's computer. The g_code 315, f_code 316, l_code 317, and sess_code 318 are stored in the first-party cookie 102. The f_code 316 is a global code stored in the Flash cookie 104. The g_code 315 is also stored in the third-party cookie 103 and Flash cookie 104.

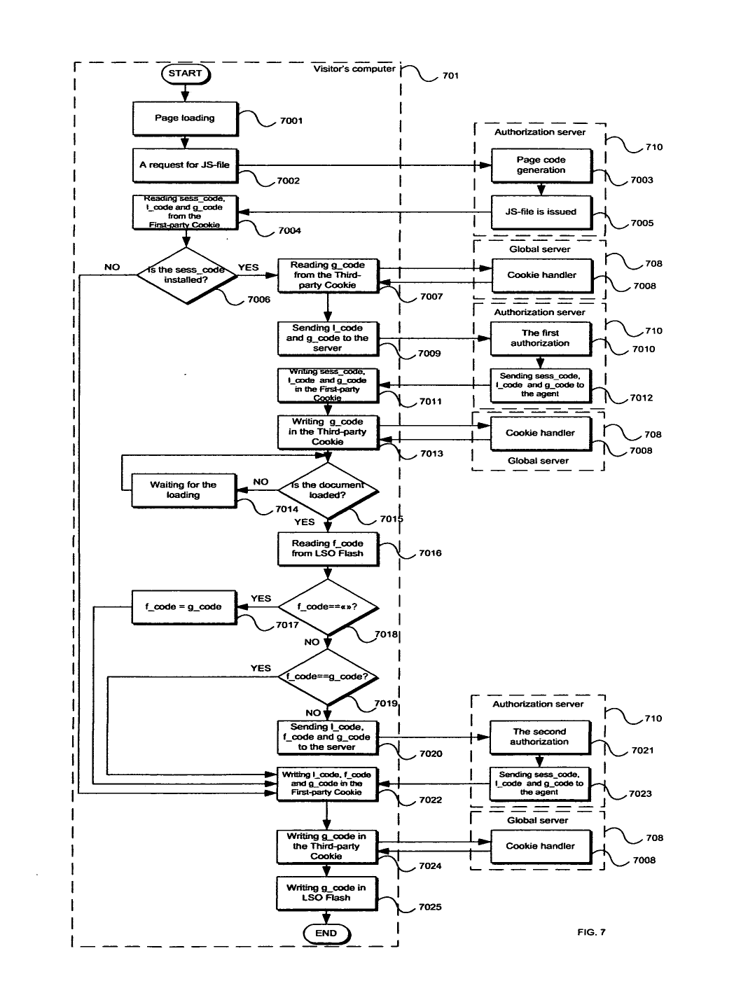

FIG. 7 shows the identification procedure in detail as a block diagram. During the loading of a webpage 7001, a request is sent to an authorization server 110 for a Javascript file 7002, which generates a unique Javascript code for a page 7003 and issues the Javascript code to the visitor's browser 7005. The Javascript code is embedded in the HTML page's DOM and serves as identification. In the preferred embodiment of the invention, this Javascript code is called an agent. The agent performs an attempt to read the values of sess_code 318, l_code 317, and g_code 315 from the first-party cookie 104. In the event of condition 3006, variable sess_code 318 is checked for existence. If it exists, it means that the visitor's session is already authorized and the identification procedure is not required. Because the lifetime of sess_code 318 is set to end before the end of the session, the existence of this variable means that the identification process has already taken place.

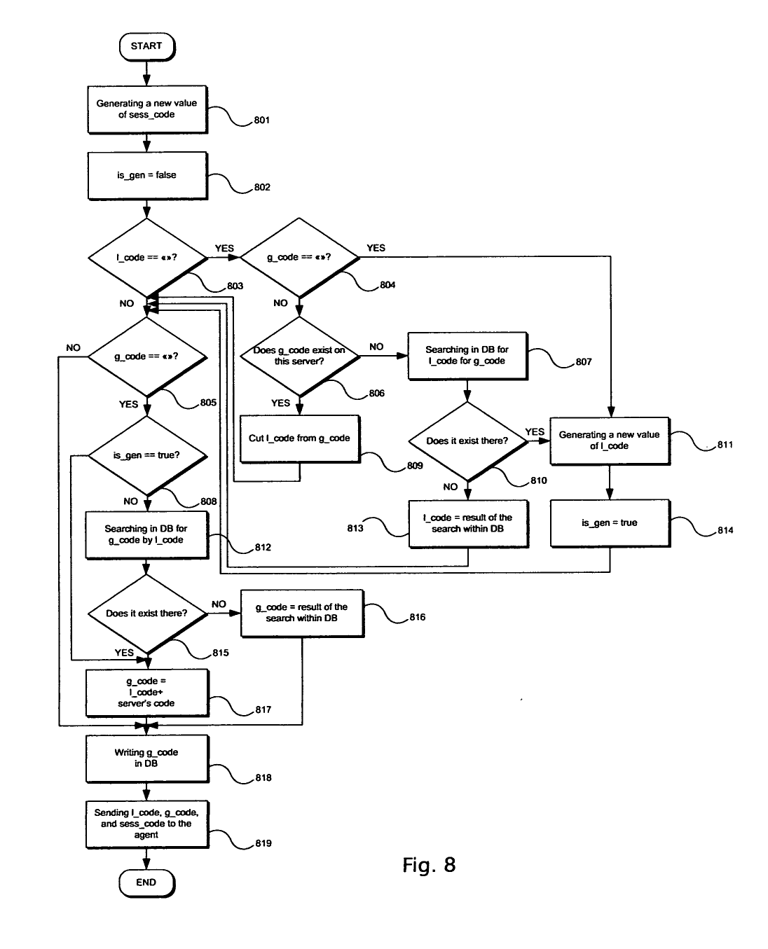

If the sess_code value is not set, the identification process begins. A request for processing of the third-party cookie 103 is sent to the global server 108. The cookie handler checks whether or not the global server cookies are installed on the visitor's computer, and returns the results of the check to the agent, thereby reading the g_code 315 from the third-party cookie 103. This step is shown in FIG. 7 as 7007. In this case, a request to the global server 108 is required to access the third-party cookie. The values of the l_code 317 and g_code 315, received during the 7004 step and 7007 step respectively, are sent to the authorization server 110, which executes the first authorization 7010, which is shown in detail in FIG. 8. After the first authorization, the server returns the received values of sess_code 318, l_code 317, and g_code 315 to the agent. If these values are already set, the authorization server checks their validity; if empty values were transmitted during the 7009 stage, the authorization server 110 generates them again.

During the next stage 7011 of the identification process, the values of the sess_code 318, l_code 317, and g_code 315, received from the authorization server, are written to the first-party cookie 104, and later to the third-party cookie 103 as well, as part of the request to the global server 108. The processing and writing steps are shown in the block diagram as 7008 and 7013. This is the final step of the first authorization process.

The next stage begins by checking the value of the f_code 316, which is stored in Flash cookie 104. This cannot be accomplished until the HTML file is fully loaded, which is illustrated by blocks 7014 and 7015. Once the file is loaded, the f_code 316 is read from Flash cookie 104. The access to the Flash cookie 104 is provided via Flash script, which is downloaded from the authorization server 110. The downloaded script reads the f_code value 7016 and transmits this value to the Javascript. Then, a check is performed for the existence of sess_code 318; if it is not yet set, it is given the value of the g_code 317 and the second authorization procedure is omitted.

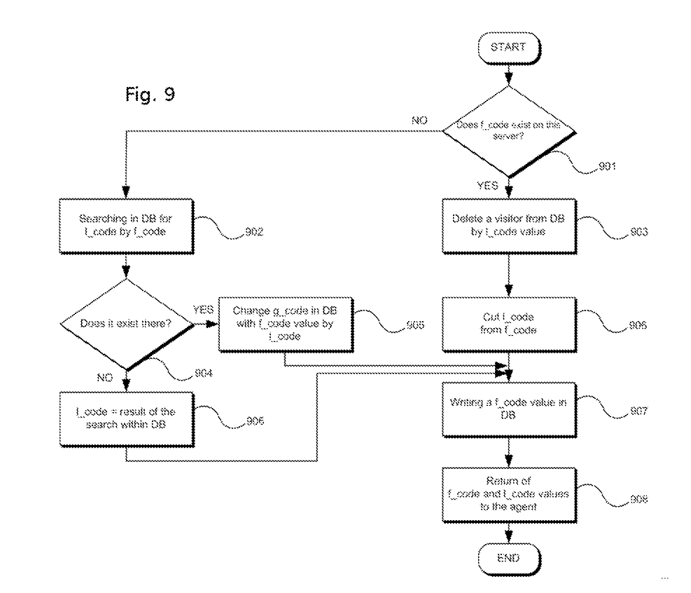

If the f_code was successfully read from the Flash cookie 104, then the g_code and f_code are compared, as is shown in 7019. If those values are the same, then the second authorization procedure is not required; if they are different, then the values of l_code 317, f_code 316, and g_code 315 are sent to the authorization server 110, and used to perform the second authorization procedure, which is shown as a block diagram in FIG. 9. After the second authorization, the server sends the adjusted values of the l_code 317, f_code 316, and g_code 315 to the agent. The agent writes the received values to the first-party cookie, in step 7022, to the third-party cookie, in step 7024, and to the Flash cookie, in step 7025. Access to the third-party cookie 03 is provided by a request to the global server 108, whereas access to the Flash cookie 104 is provided by the previously downloaded Flash script.

FIG. 8 shows a block diagram of the first authorization procedure. L_code 317 and g_code 315 are transmitted at the start of the procedure. The authorization server generates a unique session code in step 801, whose structure is shown in FIG. 5, and sets a flag tag for “new code generation” to “false” in step 802. If the l_code value is not set 802 and the g_code value is not set 804, a new l_code is generated 811, and a “new code generation” flag tag is set to “true” 814. If the g_code value is set, the next step 806 is to check whether or not it belongs to the current authorization server. This is done by comparing the more significant bits of the g_code with the current authorization server's code. If the g_code was created by the same server, then the l_code is generated from the g_code in step 809 by only using the less significant bits of the g_code; otherwise, a search is performed for an l_code that corresponds to the g_code in the database of the authorization server, in step 807. If a corresponding l_code is found in the database, then the l_code assumes that value in step 813; otherwise, a new l_code value is generated in step 811. It should be noted that the l_code and g_code may not match, since the g_code may have been created by a different authorization server.

Next, the existence of the g_code is checked, in step 805. If the g_code exists, its value is written to the authorization server database in step 818; otherwise, a new g_code value is created, as shown in blocks 808, 812, 815, 816, and 817, and then written to the authorization server database in step 818. In the last step 819, the authorization server 10 transmits the values of the sess_code 318, l_code 317, and g_code 315 to the agent.

This first authorization algorithm accounts for the following possible situations:
1. If the visitor has neither an l_code nor a g_code, the authorization server assigns new values for the l_code and the g_code to the visitor.
2. If the visitor has a g_code but no l_code, there are two possibilities:
   a. If the g_code was created by the same authorization server as the one currently used by the visitor, the l_code is simply extracted from the g_code. This can happen if the visitor previously visited another site that was also connected to this server, or if the visitor deleted the cookie for the local site. So, a visitor who has visited different sites that are connected to the same authorization server will have an l_code that is identical to the less significant parts of the g_code.
   b. If the g_code was created by a different authorization server, then a new l_code should be generated, while the g_code should remain the same. This is possible if the visitor previously visited another site that was connected to a different authorization server. In that case, a visitor who visits different sites that are connected to the same authorization server, but who initially received the code from another authorization server, will have different l_code values for each site.
3. If the visitor has an l_code but no g_code, the algorithm generates a new g_code from the concatenation of the authorization server's code and the l_code. The way this situation is handled also depends on what type of g_code was lost—the “native” g_code belonging to the authorization server, or a “foreign” g_code belonging to a different authorization server. In any event, because there is no g_code, a request is made to the database, and a search is made for a g_code that corresponds to the visitor's l_code.

FIG. 9 shows a block diagram of the second authorization procedure. The f_code 316 and g_code 315 are transmitted to the entry point of the procedure. The first step 901 of the second authorization procedure is to check whether or not the f_code belongs to the current authorization server. If the f_code belongs to the current authorization server, the visitor's l_code is deleted from the authorization database in step 903 and the visitor receives a new l_code value in step 906. This situation may occur if the visitor was identified as a new visitor during the first authorization process, but later an existing visitor code was found in Flash cookie 104. Usually, this happens if a visitor uses different browsers to visit the same site. Because the first authorization procedure only uses cookies, which do not work across different browsers, the visitor's l_code and g_code would not be found during the first authorization procedure and the visitor is mistakenly counted as new; however, the second authorization process corrects the error and replaces the visitor's code with the one found in the Flash cookie 104.

If the f_code value was generated by another authorization server, a search for the corresponding code is performed in the authorization server database in step 902. If nothing is found, the g_code is replaced with the f_code in step 905 and is written to the authorization server database in step 907. During the last step 908, the authorization server 10 transmits the received values of the f_code 316 and the l_code 317 to the agent.

The second authorization procedure performs the following functions. First of all, it allows for the overwriting of the g_code if there is a mismatch between the g_code value stored in the 3^{rd} party cookie and in the Flash cookie. The procedure begins by trying to find the l_code from the g_code (if it belongs to the same authorization server) or from the authorization server database, which stores corresponding l_codes and g_codes. Secondly, if there is an error in a code, the second authorization procedure deletes the visitor with the erroneous code from the database.

1. A method of identifying a visitor to a website, comprising:
receiving a first communication regarding a request by a client device for a web page;
embedding a script in the requested web page, and using the script to perform the following functions:
reading a first-party cookie and determining the values of a plurality of visitor identification codes from the first-party cookie;
if the first-party cookie shows that the identification process has not already taken place, reading a third-party cookie (if possible) and determining the values of a plurality of visitor identification codes from the third-party cookie;
if any of the plurality of visitor identification codes are missing, generating new visitor identification codes;
transmitting the visitor identification codes to an authorization server to identify the visitor;
reading a Flash cookie (if possible) and determining the values of a plurality of visitor identification codes from the Flash cookie;
if a visitor identification code exists in the Flash cookie that is older than the visitor identification codes in the first-party cookie or the third-party cookie, or if a visitor identification code exists in the Flash cookie but not in the first-party or third-party cookie, setting the value of said visitor identification code to the one found in the Flash cookie;
transmitting the visitor identification codes to an authorization server to identify the visitor.

2. A system for identifying a visitor to a website, comprising:
a client device comprising at least one web browser capable of accepting cookies;
at least one authorization server device in communication with the client device, wherein the server device is configured to perform actions including:
reading a first-party cookie from the client device and determining the values of a plurality of visitor identification codes from the first-party cookie;
reading a third-party cookie from the client device and determining the values of a plurality of visitor identification codes from the third-party cookie;
reading a Flash cookie from the client device and determining the values of a plurality of visitor identification codes from the Flash cookie;
if any of the visitor identification codes are missing or incorrect, using the other visitor identification codes to replace them, or generating new ones;
using the visitor identification codes to identify the visitor.

3. The method of claim 1, wherein a missing or incorrect visitor identification code is replaced using information found in the other visitor identification codes.

4. The method of claim 1, wherein at least one of the visitor identification codes includes information identifying the authorization server that generated it.

5. The method of claim 1, wherein the script is loaded to the client device from the authorization server where the web page is registered.

6. The method of claim 1, where the third-party cookie is processed by a global authorization server distinct from the plurality of authorization servers.
